(19) United States
(12) Patent Application Publication
(10) Pub. No.: US 2013/0335774 A1
(43) Pub. Date: Dec. 19, 2013

(54) DOCUMENT DATA TRANSMITTING AND RECEIVING SYSTEM, IMAGE FORMING APPARATUS, DOCUMENT READING APPARATUS, INFORMATION PROCESSING APPARATUS, AND DOCUMENT DATA TRANSMITTING AND RECEIVING METHOD

(71) Applicant: KONICA MINOLTA, INC., Tokyo (JP)

(72) Inventor: Takeshi KATO, Kawasaki-shi (JP)

(21) Appl. No.: 13/918,574

(22) Filed: Jun. 14, 2013

(30) Foreign Application Priority Data
Jun. 15, 2012 (JP) 2012-136378

(51) Int. Cl. G06F 3/12; H04N 1/00

(52) U.S. Cl. CPC G06F 3/1296; H04N 1/0097
USPC 358/1.15

(57) ABSTRACT

There is provided a document data transmitting and receiving system that includes an information adding unit to add information of a storage location for document data to a print job; a print job transmitting unit to transmit the print job; a print job receiving unit to receive the print job transmitted by said print job transmitting unit; a printing unit to print on a print medium based on the print job; a reading unit to read the document existing on the print medium printed by the printing unit as document data; a storage location setting unit to set a storage location for the document data based on any one of the information of storage location added to the print jobs received by the print job receiving unit.

### CROSS-REFERENCE TO RELATED APPLICATION

This application is based on Japanese Patent Application No. 2012-136378 filed on Jun. 15, 2012, the contents of which are incorporated herein by reference.

### BACKGROUND

1. Technical Field

The present invention relates to a document data transmitting and receiving system, an image forming apparatus, a document reading apparatus, an information processing apparatus, and a document data transmitting and receiving method.

2. Description of Related Art

Development of application programs for personal computers in recent years has facilitated effectively and electronic data-based proofreading and version management for documents are performed on the personal computers.

Meanwhile, hard-copy documentation is nonetheless prevalent in terms of ease of use and simplicity, updates are often made by physically adding corrections and comments to documents that are printed on sheets of paper.

Integrated paperless management of pre-updated document data and updated document data can be achieved by scanning documents updated on a sheet of paper and storing the scanned documents as document data.

However, operation or settings of image forming apparatuses for transmitting the updated document data to a desired storage location to store is complicated.

There is a technique that allows the image forming apparatuses to be freed from the need of setting destinations of the updated document data. Unexamined Japanese Patent Publication No. 2008-84324 discloses as follows. Specifically, document index IDs are added to document data to be stored in a database, and when the document based on the document data is to be printed on a sheet of paper, the same document index ID as document index ID added to the document data is printed with the document on the sheet of paper.

After making updates on the document printed on the sheet of paper, the sheet of paper is scanned and the document index ID is recognized in the scanned document data. The updated document data is then transmitted to a dedicated document database provided for document data, and the updated document data is stored as an updated data of an original document data that has the same document index ID as that of the updated document data.

According to the above prior-art technique, all the document data should be transmitted to and stored in the dedicated document database. Therefore, by the above prior-art technique it is not possible to transmit the updated document data to a storage location selected arbitrarily from among different storage locations.

### SUMMARY

To achieve at least one of the abovementioned objects, a document data transmitting and receiving system reflecting one aspect of the present invention comprises an information adding unit to add information of a storage location for document data to a print job; a print job transmitting unit to transmit said print job to which said information of storage location for document data added by said information adding unit; a print job receiving unit to receive said print job transmitted by said print job transmitting unit; a printing unit to print on a print medium based on said print job received by said print job receiving unit and output said printed print medium; a reading unit to read a document existing on said print medium printed by said printing unit as document data; a storage location setting unit to set a storage location for said document data read by said reading unit based on any one of said information of storage location added to said print jobs received by said print job receiving unit; and a document data transmitting unit to transmit said document data read by said reading unit to said storage location that is set by said storage location setting unit to store.

The document data transmitting and receiving system preferably further comprises a storage location display unit to display said storage locations based on said information added to each of said print jobs received by said print job receiving unit along with histories of said print jobs received by said print job receiving unit so that said storage locations are selectable by a user, wherein said storage location setting unit sets said storage location selected by the user from among said storage locations displayed by said storage location display unit as said storage location for document data.

The document data transmitting and receiving system preferably further comprises a print setting display unit to display a print setting of said print job received by said print job receiving unit so that said print setting is selectable by a user; and a read setting unit to set a read setting for said reading unit to read said document based on said print setting selected by the user from among said print settings displayed by said print setting display unit.

The document data transmitting and receiving system preferably further comprises a comparing and judging unit to compare said document data included in said print job received by said print job receiving unit with said document data read by said reading unit, and judge that these documents are correspondent to each other if these documents are correspondent at least partly to each other, wherein if it is judged by said comparing and judging unit that said document data included in said print job and said document data read by said reading unit correspond to each other, said storage location setting unit sets said storage location based on said information added to said print job includes said document data that judged to correspond to said document data read by said reading unit as the storage location for said document data read by said reading unit.

The document data transmitting and receiving system preferably further comprises a read setting unit to set read setting for said reading unit to read said document based on print setting of said print job includes document data that judged to correspond to said document data read by said reading unit if it is judged by said comparing and judging unit that said document data included in said print job corresponds to said document data read by said reading unit.

The document data transmitting and receiving system preferably further comprises a status display unit to display a status of at least any one of printing of said document on said print medium by said printing unit, outputting of said print medium by said printing unit, reading of said document by said reading unit, transmitting of said document data by said document data transmitting unit, or storing of said document data transmitted by said document data transmitting unit, or display completion of at least any one of outputting of said print medium by said printing unit, reading of said document by said reading unit, transmitting of said document data by said document data transmitting unit, or storing of said document data transmitted by said document data transmitting unit.

The document data transmitting and receiving system is preferably constituted such that said information adding unit further adds information of e-mail address to said print job, and said system further comprises a mail-transmitting unit to transmit an e-mail notifying completion of any one of outputting of said print medium printed based on said print job by said printing unit, reading of said document by said reading unit, transmitting of said document data by said document data transmitting unit, or storing of said document data transmitted by said document data transmitting unit, to said e-mail address based on said information added to said print job, when said completion has resulted.

The document data transmitting and receiving system preferably further comprises a user interface display unit to access said storage location set by said storage location setting unit prior to transmitting of said document data by said document data transmitting unit, and display an interface for entering authentication information by a user for user authentication when it has been judged that the user authentication is required in order that said document data is allowed to be stored in said storage location accessed.

The document data transmitting and receiving system preferably further comprises a file name setting unit to recognize file names of existing document data stored in said storage location by accessing said storage location set by said storage location setting unit or confirming histories of documents read by said reading unit, and set a file name for said document data read by said reading unit to a file name different from file names of said existing document data.

The document data transmitting and receiving system is preferably constituted such that said storage location display unit displays only said print job histories for said print jobs to which said information of storage location is added from among said print jobs received by said print job receiving unit.

The document data transmitting and receiving system is preferably constituted such that said print jobs to which said information of storage location is added include a print job not including said document data to be printed.

The document data transmitting and receiving system preferably further comprises a warning display unit to display a warning message when it has been judged by said comparing and judging unit that said document data read by said reading unit does not correspond to any one of said document data included in said print jobs as the result of comparing said document data included in said print jobs with said document data read by said reading unit.

The document data transmitting and receiving system is preferably constituted such that said a mail-transmitting unit transmits an e-mail for notification of warning to said e-mail address based on said information added to said print job when it has been judged by said comparing and judging unit that said document data read by said reading unit does not correspond to any one of said document data included in said print jobs as the result of comparing said document data included in said print jobs with said document data read by said reading unit.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a document data transmitting and receiving system in accordance with a first embodiment of the present invention.

FIG. 2 is a block diagram illustrating a configuration of an information processing apparatus in accordance with the first embodiment of the present invention.

FIG. 3 is a block diagram illustrating a configuration of an image forming apparatus in accordance with the first embodiment of the present invention.

FIG. 4 is a flowchart illustrating a document transmitting and receiving method in accordance with the first embodiment of the present invention.

FIG. 5 is a dialog of a printer driver of the information processing apparatus in accordance with the first embodiment of the present invention.

FIG. 6 is a diagram illustrating a print job configuration generated by the information processing apparatus in accordance with the first embodiment of the present invention.

FIG. 7 is a dialog of the printer driver of the information processing apparatus in accordance with the first embodiment of the present invention, where an e-mail address is to be added to the print job.

FIG. 8 is a table of histories of print jobs displayed on a display unit of the image forming apparatus in accordance with the first embodiment of the present invention.

FIG. 9 is a scan job operation screen displayed on the display unit of the image forming apparatus in accordance with the first embodiment of the present invention.

FIG. 10 is a destination list in the scan job operation screen displayed on the display unit of the image forming apparatus in accordance with the first embodiment of the present invention.

FIG. 11 is a flowchart illustrating a document transmitting and receiving method in accordance with a second embodiment of the present invention.

FIG. 12 is a flowchart illustrating a document transmitting and receiving method in accordance with a third embodiment of the present invention.

FIG. 13 is a flowchart of a subroutine of the flowchart of the document data transmitting and receiving method in accordance with the third embodiment of the present invention.

FIG. 14 is a scan job operation screen displayed on the display unit of the image forming apparatus in accordance with the third embodiment of the present invention.

FIG. 15 is a print job configuration that does not include a document data created by the information processing apparatus in accordance with the fourth embodiment of the present invention.

FIG. 16 is a dialog of the printer driver of the information processing apparatus in accordance with the fourth embodiment of the present invention, in a case where the print job does not include the document data.

### DETAILED DESCRIPTION

### First Embodiment

The following provides detailed description of a document data transmitting and receiving system, an image forming apparatus, a document reading apparatus, an information processing apparatus, and a document data transmitting and receiving method configured in accordance with the first embodiment of the present invention with reference to the figures.

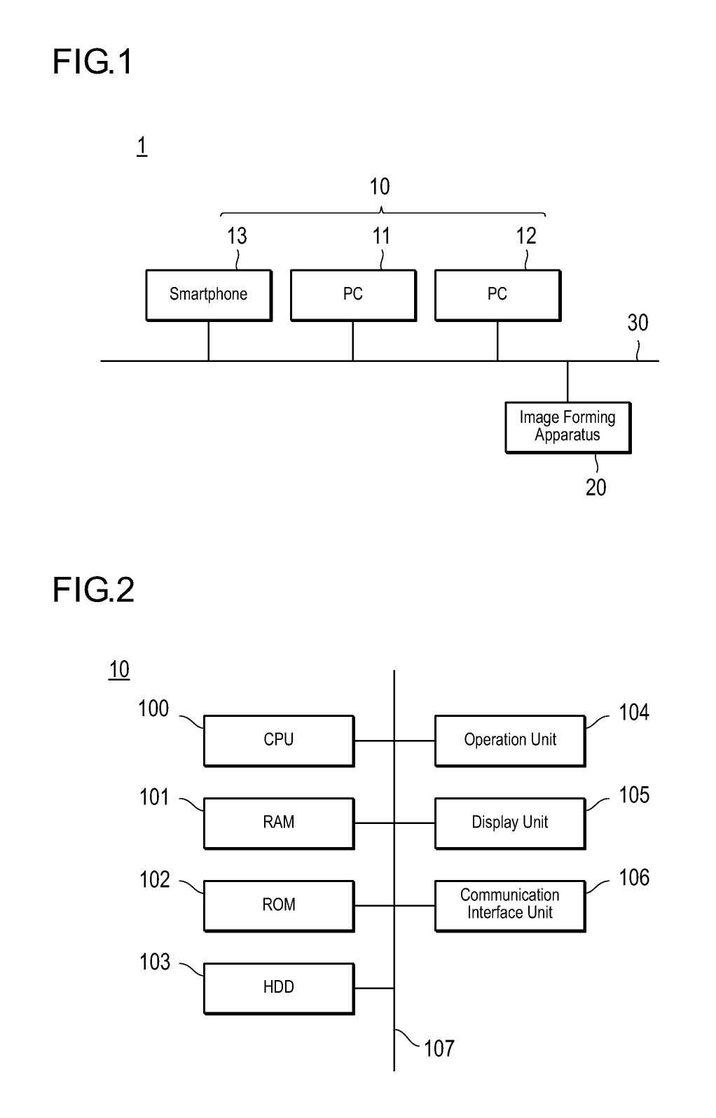

FIG. 1 is a block diagram illustrating a document data transmitting and receiving system in accordance with the present embodiment.

As illustrated in FIG. 1, the document data transmitting and receiving system 1 comprises an information processing apparatus 10 and an image forming apparatus 20.

The information processing apparatus 10 provides functions of an information adding unit, a print job transmitting unit, and a status display unit in the context of the present invention. The image forming apparatus 20 provides functions of a print job receiving unit, a printing unit, a reading unit, a storage location setting unit, a document data transmitting unit, a storage location display unit, a print setting display unit, a read setting unit, a comparing and judging unit, a status display unit, a mail-transmitting unit, a user interface display unit, a file name setting unit, and a document reading apparatus in the context of the present invention.

The information processing apparatus 10 and the image forming apparatus 20 are connected to each other via a network 30. The network 30 may comprise a wired or wireless LAN (Local Area Network) constructed by interconnected computers and network devices based on Ethernet (Registered Mark), BLUETOOTH (Registered Mark), and IEEE802.11 standards, or a WAN (Wide Area Network) constructed by multiple LANs interconnected by a dedicated line.

The document data transmitting and receiving system 1 may comprise more than one information processing apparatus 10, and information processing apparatus 10 may be constructed by personal computers 11, 12 and a smartphone 13. However, the number of the information processing apparatus 10 is not limited. Therefore, the number of the information processing apparatus 10 may be one for example. Also, the types of the information processing apparatus 10 are not limited. Therefore, the information processing apparatus 10 may comprise a PDA (Personal Digital Assistant) or a smartbook.

The information processing apparatus 10 generates a print job and transmit the print job to the image forming apparatus 20.

The print job includes document data and print settings. Also, information of a location where the document data is to be stored (hereafter simply referred to as “storage location”) is added to the print job. Specifically, the print job includes the document data, the print settings, and the storage location as information.

The storage location may be PC (Personal Computer) 11, 12, the smartphone 13 that are connected to the network 30, or a directory of a HDD (Hard Disk Drive) of a server.

The document data is defined as data of a document to be printed, and the document data may include various types of data such as image data, vector data (graphic data), and text data, for example. Also, the document data may be a PDF (Portable Document Format) file or a TIFF (Tagged Image File Format) file, for example. The print setting is defined as setting of a format of printing paper, and may be paper size, color/monochrome printing, single-side/duplex printing, print area, N in 1 printing (i.e., page layout on one side of printing paper), staple, punch, folding line, watermark, orientation of document, and number of copies to be printed, for example.

The image forming apparatus 20 prints a document on a print medium based on the print job received from the information processing apparatus 10, and output the printed medium. The print medium may be a sheet of paper, however, the print medium is not limited to this specific example. For example, the print medium may be an envelope or a label for CD-R discs. Hereinafter, description is made considering the print medium as a sheet of paper.

The document printed on the sheet of paper by the image forming apparatus 20 may be updated by making corrections and comments for example onto the document printed on the sheet of paper, and the image forming apparatus 20 scans an updated document existing on the sheet of paper as a result of the updating (hereafter referred to as “updated document”). Thus, the image forming apparatus 20 reads the updated document as document data (hereafter referred to as “updated document data”) for which corresponding updates have been made to the document data originally included in the print job. Also, the image forming apparatus 20 transmits the updated document data to a target storage location based on the storage location information that has been added to the print job by the information processing apparatus 10, so that the transmitted updated document data is stored in the storage location.

FIG. 2 is a block diagram illustrating a configuration of an information processing apparatus in accordance with the present embodiment of the present invention.

As shown in FIG. 2, the information processing apparatus 10 includes a CPU (Central Processing Unit) 100, a RAM (Random Access Memory) 101, a ROM (Read Only Memory) 102, a HDD 103, an operation unit 104, a display unit 105, and a communication interface unit 106. These are connected to each other via a bus 107 for transmitting and receiving of signals.

The CPU 100 controls these units and executes various arithmetic processing in accordance with associated programs.

The RAM 101 stores temporarily programs and data so as to provide a work area.

The ROM 102 stores various programs and data therein.

The HDD 103 stores various data and programs including an operating system.

The operation unit 104 is configured for various operations such as input operation and may include a pointing device such as a mouse, a keyboard, and a touch panel.

The display unit 105 may be a liquid crystal display and display various types of information.

The communication interface unit 106 is an interface for communications with external devices, and may be constructed by a network interface based on Ethernet (Registered Mark), SATA (Serial Advanced Technology Attachment), PCI Express, USB, and IEEE1394, wireless communications interfaces based on BLUETOOTH (Registered Mark) and IEEE8020.11, and a telephone line interface for connection to telephone lines.

The user may activate an application program in the information processing apparatus 10, open a file of the document data to be printed, and use a printer driver to set print settings for the document data and set the storage location to be added to the print job. Further, the print job that includes information of the document data, the print settings, and the storage location is transmitted from the information processing apparatus 10 to the image forming apparatus 20.

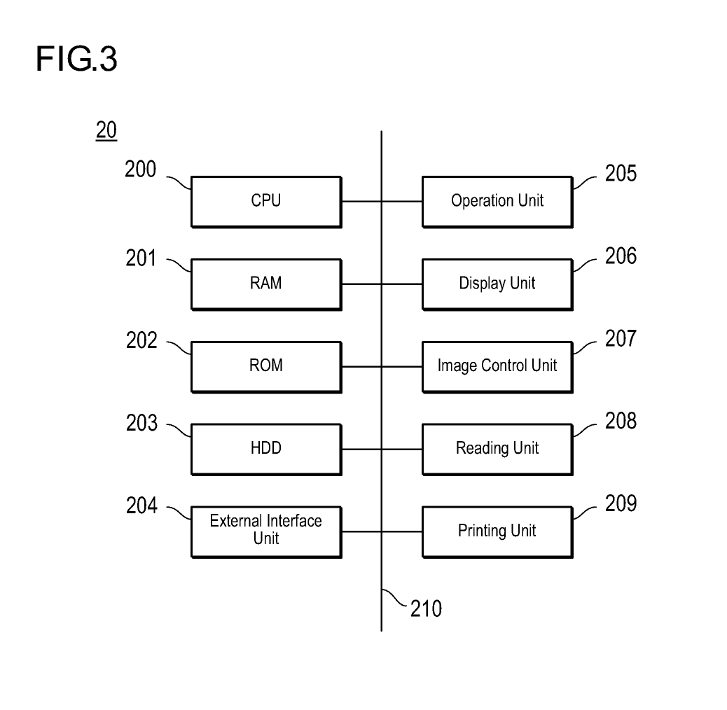

FIG. 3 is a block diagram illustrating a configuration of an image forming apparatus in accordance with the present embodiment of the present invention. The image forming apparatus may be configured by a MFP (Multi-Function Peripheral).

As shown in FIG. 3, the image forming apparatus 20 comprises a CPU 200, a RAM 201, a ROM 202, an HDD 203, an external interface unit 204, an operation unit 205, a display unit 206, an image control unit 207, a reading unit 208, and a printing unit 209. These constituent elements are connected to each other via a bus 210 for transmitting and receiving signals.

The CPU 200 controls the above-mentioned constituent element and executes various arithmetic operations in accordance with associated programs. Specifically, the CPU 200 provides overall control of various processing, printing, and storing in cooperation with the constituent element of the image forming apparatus 20.

The RAM 201 temporarily stores various data that is received via the reading unit 208 or the network 30. The document data that is stored in the RAM 201 is processed by the CPU 200, and transmitted to the HDD 203 and the image control unit 207 as required.

The HDD 203 is a device to store therein various programs including programs for the CPU 200 to control the constituent elements of the image forming apparatus 20 and various types of data including the document data which has been made image processing. The programs and data stored in the HDD 203 are read by the CPU 300 as required to be executed or processed.

The external interface unit 204 is an interface for communications with external devices, and may comprise such network interfaces based on Ethernet (Registered Mark), SATA, PCI Express, USB, IEEE1394, a local area connection interface such as wireless communications interface based on BLUETOOTH (Registered Mark) and IEEE802.11, and a telephone line interface for connection to telephone lines.

The operation unit 205 may comprise a touch panel for various settings, a numerical key for setting a number of copies to be printed, and other fixed keys such as a start key to start operation, a stop key to stop the operation, and a reset key to initialize various of settings.

The display unit 206 displays various information and may comprise a touch panel for making various settings, a numerical key for setting the number of copies, and other fixed keys such as a start key to start operation, a stop key to stop the operation, and a reset key to initialize settings, and an indicator lamp. These functions do not need to be redundantly provided in the operation unit 205 and the display unit 206, therefore, either the operation unit 205 or the display unit 206 may feature such functions.

The image control unit 207 rasterizes the document data included in the print job and makes layout processing.

The reading unit 208 focuses a light beam onto a sheet of paper, which may be a manuscript, placed upon a predetermined reading position of a platen by a light source such as a fluorescent lamp. The reading unit 208 photoelectrically convert its reflected light by a imaging device such as a charge coupled device (CCD) as an image sensor so as to generate a document data (bitmap data) based on its electrical signal. The reading unit 208 provides such scanning feature to read the document existing in the sheet of paper as the document data.

The printing unit 209 prints a document on a sheet of paper based on the document data included in the print job through electrophotographic methodology including charging, exposure, developing, transcription, and fixing processes, and outputs the printed sheet of paper. Specifically, the printing unit 209 prints the document data included in the print job received by the external interface unit 204 or the document data that has been read by the reading unit 208 using developing material and outputs the printed sheet of paper.

With the above-described configuration, the image forming apparatus 20 receives the print job from the information processing apparatus 10 and outputs a printed medium based on the document data in accordance with the print settings included in the print job.

Also, the image forming apparatus 20 makes the display unit 206 display histories of print jobs along with the storage location included in the print job so that the user can select. When the document printed on the sheet of paper is read by the reading unit 208, the user can select any one of the storage locations displayed on the display unit 206, so that the user can transmit the document data read by the reading unit 208 to the selected storage location to store the document data in.

The installation site of the image forming apparatus 20 is not limited. For example, the user may use the smartphone 13 and transmit the print job to the image forming apparatus 20 that is installed in a convenience store to print a document. Also, for example, the document data scanned by the image forming apparatus 20 installed in a convenience store may be transmitted to the smartphone 13 that is the storage location added to the print job.

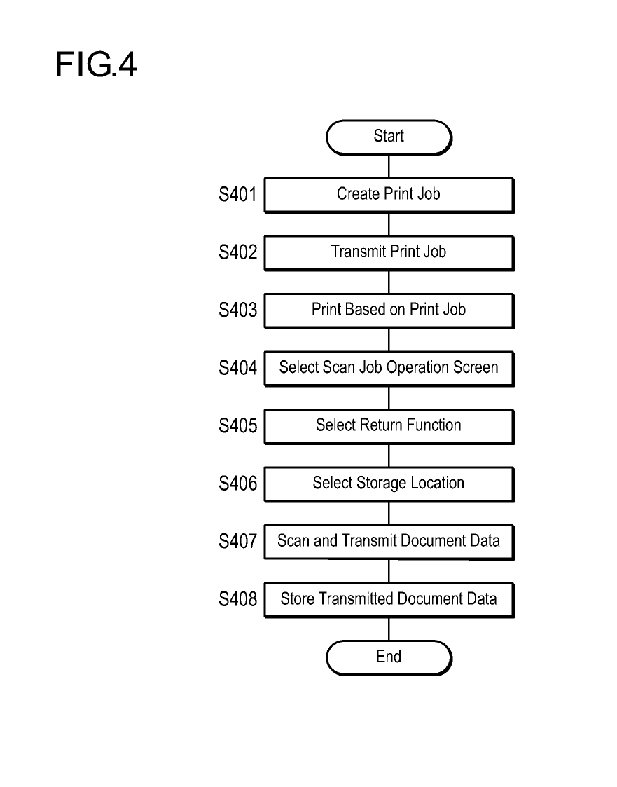

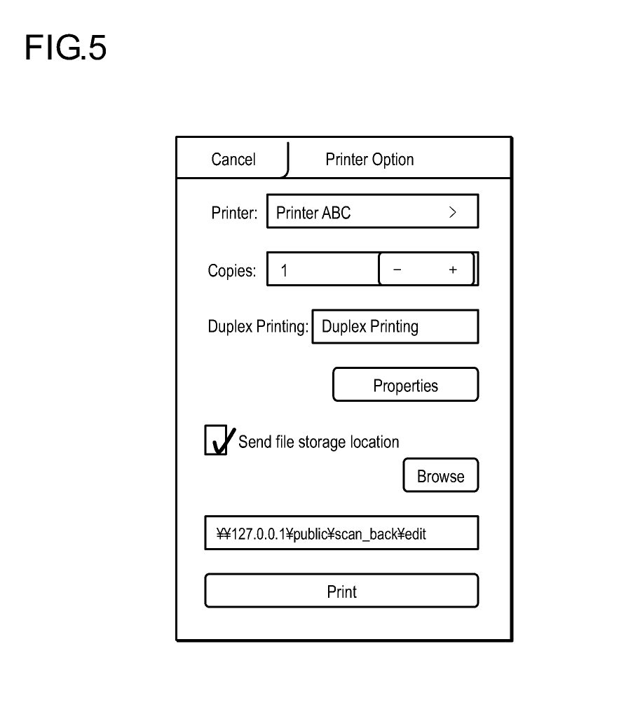

FIG. 4 is a flowchart illustrating a document transmitting and receiving method in accordance with the present embodiment of the present invention. The following paragraphs describe the document transmitting and receiving method in accordance with the present embodiment with step numbers expressly showed. The flowchart may be implemented by the document data transmitting and receiving system in accordance with present embodiment.

The user makes the information processing apparatus 10 activate an application program for creating a document, opens a file of the document data to be printed, and opens a dialog which is the user interface of the printer driver. The user inputs print settings and information of the storage location in the dialog. The printer driver creates a print job that includes document data whose content is made viewable by the application program, and the print settings and the storage location that have been input by the user (S401).

When the document data to be printed is a PDF file or a PS (PostScript) file, the print job may be transmitted to the image forming apparatus 20 using a general direct print feature implemented in the controller without operation by the above application program. A hot folder is a utility that supports a general direct print feature.

Also, the print job may be transmitted to the image forming apparatus 20 with an application program adapted for handling jobs of the image forming apparatus 20 activated on the information processing apparatus 10 by uploading thereto the document data.

FIG. 5 is a dialog of a printer driver.

As shown in FIG. 5, in the dialog of the printer driver, the image forming apparatus 20 (a printer in FIG. 5) is selected to print document data, and the print settings such as the number of copies and duplex printing is input. Also, pressing a “Properties” button will cause a screen to be displayed for entering other print settings, and print settings can be input to the screen.

Also, the user may make the storage location added to the print job by checking a “Send file storage location” checkbox and inputting a directory as the storage location. Input of the storage location can also be done by pressing a “Browse” button, thereby displaying directories, and selecting a directory to be included as the storage location in the print job from among the displayed directories. Settings for adding the storage location to the print job may also be done in the context of the property setting of the print job. Also, settings for adding the storage location to the print job may be done by the above-mentioned utility that supports a general direct print feature.

The user may set a directory in which the document data included in the print job is stored as the storage location to be added to the print job. By doing so, the updated document data is obtained by printing an pre-updated document on a sheet of paper based on the print job, updating the document on the sheet of paper, and scanning the updated sheet of paper. And, the updated document data can be easily stored in the same location as that of the pre-updated document data.

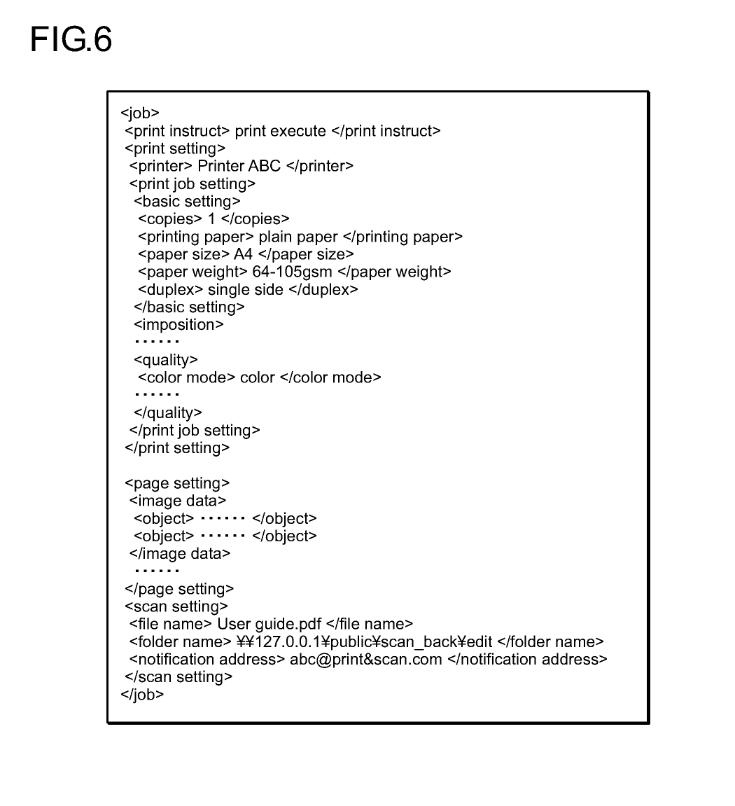

FIG. 6 is a diagram illustrating a print job configuration.

As shown in FIG. 6, the print job configuration includes a print instruction, print setting, page setting, and scan setting. As the print setting in the print job, a content of the print settings input in the dialog of the printer driver is described. As the page setting in the print job, a content of the settings of image data (object) of each page constituting the document data included in the print job is described. Also, as the scan setting, contents of a file name to be given to the updated document data obtained by scanning the updated document, and a folder name as a directory of the storage location are described. These settings may be described in jobs of Post Script, for example.

Further, it is also possible to be described a destination address to which an e-mail is sent from the image forming apparatus 20 on completion of any one of the tasks including printing based on the print job, outputting a printed sheet of paper, reading the document existing on the sheet of paper, and transmitting the read document, and storing the document data transmitted from the image forming apparatus 20.

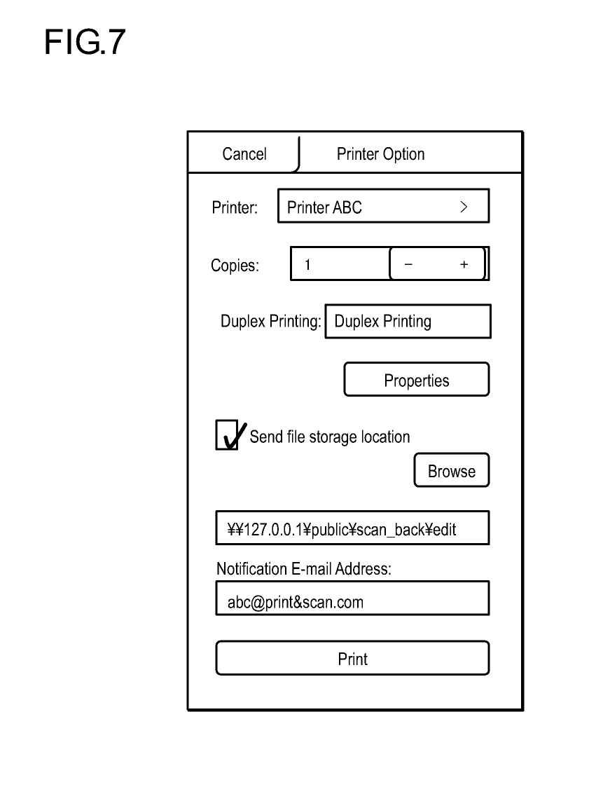

FIG. 7 is a dialog of the printer driver in case where an e-mail address is to be added to the print job.

As shown in FIG. 7, the dialog of the printer driver includes an input box “Notification E-Mail Address” for inputting an e-mail address to be added in the print job. Here, a default e-mail address may be input in advance in the input box for entering the e-mail address.

Next, in the step S402 in FIG. 4, when the “Print” button is pressed in the dialog of the printer driver, the information processing apparatus 10 transmits the print job created by the printer driver to the image forming apparatus 20 (S402). The image forming apparatus 20 prints a document on a sheet of paper based on the print job that has been received from the information processing apparatus 10, and outputs the printed sheet of paper (S403).

The histories of print jobs received from the information processing apparatus 10 are displayed on the display unit 206 of the image forming apparatus 20.

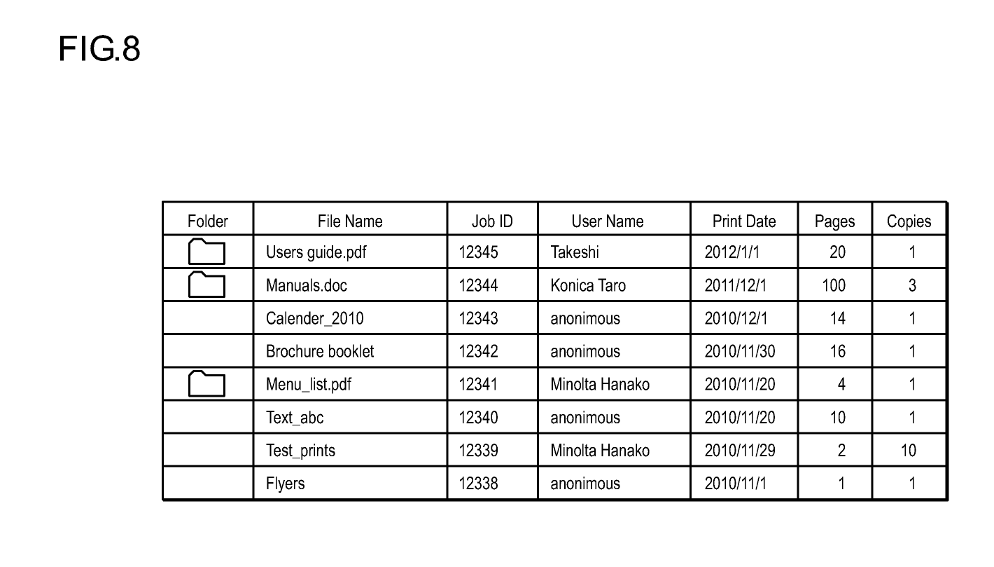

FIG. 8 is a table of histories of print jobs displayed on a display unit of the image forming apparatus.

As shown in FIG. 8, the display unit 206 of the image forming apparatus 20 displays file name of the document data included in the print job, print job ID, user name, print date, number of pages of the document data, and number of copies to be printed as histories of print jobs. Also, a mark of folder is indicated for each of the print jobs to which the storage location is added.

The histories of print jobs are displayed in a chronological order from top down according to the time when printing based on the print jobs was made. Meanwhile, the histories of print jobs may be displayed in a chronological order from top down according to the time when the print job was received.

The user updates a document printed on a sheet of paper by the image forming apparatus 20. After update of a document are made, the user operates the display unit 206 of the image forming apparatus 20 to display a scan job operation screen by selective operation for displaying the scan job operation screen (S404).

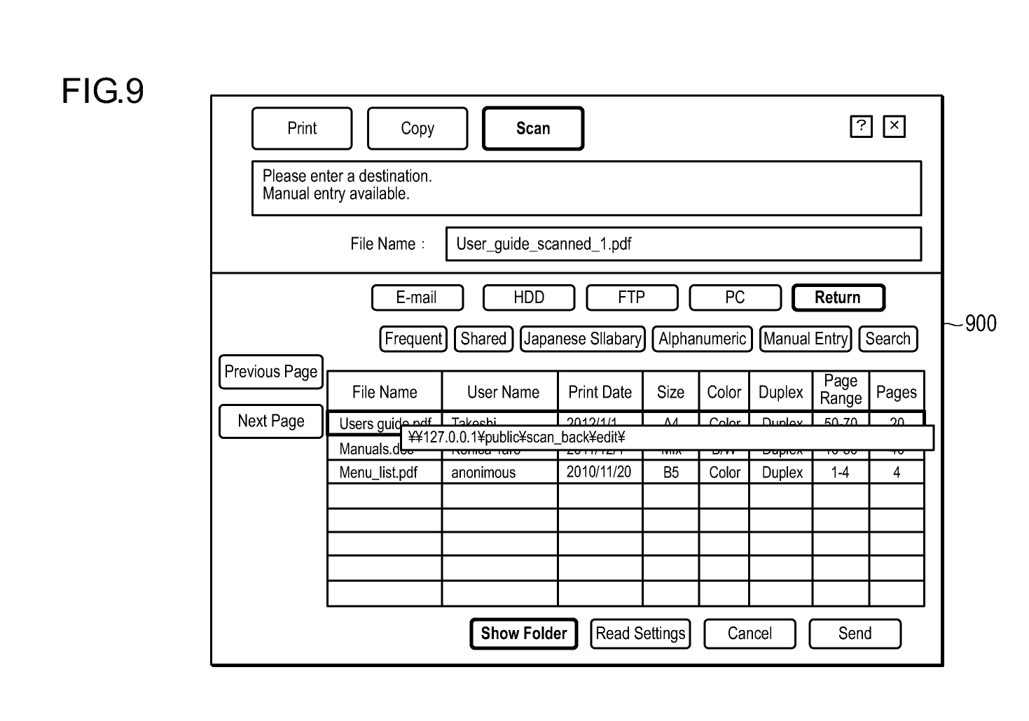

FIG. 9 is a scan job operation screen displayed on the display unit of the image forming apparatus. In FIG. 9, touch-panel buttons indicated with heavy lines are buttons that are currently selected by the user, and a “Scan” button, a “Return” button, and a “Show Folder” button are currently selected. The scan job operation screen 900 is displayed by selecting the “Scan” button.

The scan job operation screen 900 has an “E-mail” button, an “HDD” button, an “FTP (File Transfer Protocol)” button, a “PC” button, and the “Return” button, which are used to select method of transmission of the document data read by the reading unit 208. When the “E-mail” button is selected, the document data is transmitted using an e-mail. When the “HDD” button is selected, the document data is stored in the HDD 203. When the “FTP” button is selected, the document data is transmitted using FTP. When the “PC” button is selected, the document data is transmitted to a personal computer previously set its location in the network 30.

Also, when the “Return” button is selected, a return function is selected, the image forming apparatus 20 displays a list (hereafter referred to as a “destination list”) of destinations on the scan job operation screen 900. Here, the return function is a function of transmitting a document data read by the reading unit 208 to the storage location added to the print job. The destination list is a list only includes histories of print jobs having storage location information from among the print jobs whose histories are displayed on the scan job operation screen 900. The user can easily confirm which print job is added the storage location by the destination list.

The destination list is displayed in the scan job operation screen 900 of FIG. 9.

Next, in the step S405 in FIG. 4, when the return function is selected by the user, the image forming apparatus 20 displays the destination list on the scan job operation screen.

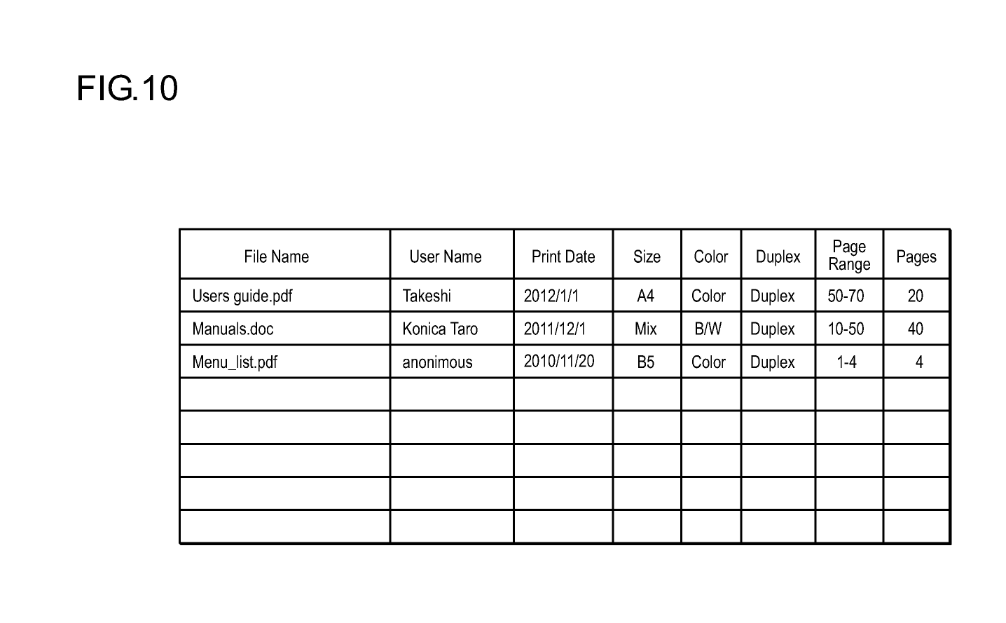

FIG. 10 is a destination list in the scan job operation screen. File name of the document data included in the print job, user name, and date of printing are listed in the destination list. Further, the print settings such as size of printer sheet, color printing, duplex printing, page range, and number of pages to be printed are listed in the destination list. The image forming apparatus 20 stores the received print jobs in the HDD 203 and read them therefrom, so that the print settings of the print jobs are listed in the destination list based on the contents of the stored print jobs.

As shown in FIG. 9, when the “Show Folder” button is selected, the image forming apparatus 20 displays a directory of a folder of the storage location as the storage location added to the print job (the print job indicated by the thick line) selected by the user from the destination list. Thus, the user can confirm and select the storage locations added to the print jobs listed in the destination list.

The storage location may be displayed by default without selection of the “Show Folder” button. Also, in view of the fact that the storage location can be private information, the storage location may only be displayed after successful user authentication.

Next, the user may select any one of the print jobs listed in the destination list, so that the storage location is set for the updated document which has been updated to the document printed in the step S403 (S406).

On this occasion, the user may select the print job that includes the pre-updated original document data, so that the storage location adding to the print job including the pre-updated document data can be selected. Thus, the updated document data updated after printing can be easily stored in a simple manner in the same storage location as the storage location adding to the print job that is the storage location of the pre-updated document data.

Also, a user may select a print job other than the print jobs that include the pre-updated document data and select the storage location added to this print job. Thus, the updated document data can be easily stored in the user's desired location in a simple manner. Therefore, the user does not need to set the storage location for the updated document data in the image forming apparatus 20 because the storage location is added to the print job in the information processing apparatus 10. Thus, it is made possible to easily store the updated document data in the storage location of the pre-updated document data or in any other desired storage location in a simple manner.

In a case where the updated document data is to be transmitted to and stored in a storage location previously set in the image forming apparatus 20 by an administrator, the storage location does not need to be set further in the image forming apparatus 20. However, when the storage location previously set in the image forming apparatus 20 is not the user's desired location, the document data has to be transferred to another storage location. Accordingly, even in the case, it is impossible to easily storing the updated document data in the user's desired location in a simple manner.

As shown in FIG. 9, the image forming apparatus 20 inputs the file name of the updated document data in the file name input box 901. The file name input in the file name input box 901 is set as the file name of the updated document data. The image forming apparatus 20 accesses the storage location selected by the user in the step S406 or confirms histories of reading of the document data by the reading unit 208 that is stored in the HDD 203. The image forming apparatus 20 recognizes file names of existing document data stored in the storage location, and a file name different from those of the existing document data is input in the file name input box 901 as the file name of the updated document data. Thus, it is made possible to protect the original document data in the storage location against being erased due to being overwritten by the updated document data, and it is also made possible to eliminate the need for the user to input the file name of the updated document data.

The image forming apparatus 20 may input a file name obtained by adding a string to the file name of the document data included in the print job in the file name input box 901 as the file name for the updated document data. Also, the image forming apparatus 20 may input a file name obtained by adding a string to the print job name into the file name input box 901 as the file name for the updated document data. Thus, a user can recognize from the file names the relevance between the updated document data and the pre-updated document data.

On the other hand, the user may input a desired file name in the file name input box 901.

Even in the case where the user inputs the desired file name in the file name input box 901, the image forming apparatus 20 can access the storage location selected by the user or confirm the read histories of the document data stored in the HDD 203. And, when the file name input by the user overlaps with the file name of an existing document data, the image forming apparatus 20 may input another file name in the file name input box 901 as a file name for the updated document data or display a warning message. Thus, in particular when more than one user make updates to a single document data included in the print job respectively, it is possible to reduce the probability that the file names of the updated document data are overlapped.

Next, when the user selects a “Send” button on the scan job operation screen 900, the image forming apparatus 20 scans the updated document on the sheet of paper. Then the image forming apparatus 20 transmits the updated document data obtained by the scanning the updated document to the storage location selected by the user in the step S406 (S407).

The image forming apparatus 20 uses the print settings of the print job selected by the user in the destination list as the read settings for scanning of the updated document. Specifically, the user can select the print job that includes the pre-updated document data and thereby select the print settings of that print job as the read settings for the scanning of the updated document. Thus, the user does not need to input respective read settings for the image forming apparatus 20, and the read settings in scanning can be identical with the print settings of the print job that includes the pre-updated document data. Also, it can be possible to reduce burden on the users associated with re-setting due to erroneous read settings and re-scanning that will follow.

In the destination list, the print settings that can also be used as the read settings for the scanning by the reading unit 208 are preferentially listed. The print settings that can serve as the read settings for the scanning may be, for example, paper size, color modes, duplex printing, number of pages to be printed, and range of page to be printed.

With regard to the print settings that are not listed in the destination list, the read settings may be set in the following manner. With regard to file formats such as PDF and TIFF, the read settings of the updated document are set such that the updated document data has the same file format as that of the pre-updated document data. Also, with regard to resolution, the read settings may be set as default settings. Also, with regard to print settings for booklet output, the read settings of the updated document can be same as the print settings of the print job that includes the pre-updated document. Thus, it is possible to provide effective two-page spread scanning in place of sequential scanning on a per-page basis.

Selection of the storage location in the destination list and the print settings as the read settings in the destination list may be done independently from each other.

Next, the updated document data that transmitted in the step S407 is stored in the storage location selected in the step S406 (S408).

The display unit 206 of the image forming apparatus 20 or the display unit 105 of the information processing apparatus 10 displays the at least one status of printing the document on the sheet of paper by the image forming apparatus 20, outputting of the sheet of paper, reading of the updated document, transmitting of the updated document data, and the storing of the transmitted updated document data. Also, the display unit 206 of the image forming apparatus 20 or the display unit 105 of the information processing apparatus 10 display notification regarding completion of any one of outputting of printed sheet of paper by the image forming apparatus 20, reading of the updated document, transmitting of the updated document data, and storing of the transmitted updated document data. Thus, the user can confirm whether or not the printing of the pre-updated document data and the storing of the updated document data are successfully performed as well as the progress situation thereof.

As described above, when an e-mail address is added to the print job as a notification address, notification regarding completion of any one of outputting of a sheet of paper, reading of the updated document, transmitting of the updated document, and storing of the updated document data may be transmitted to the e-mail address. Thus, the user can confirm by the e-mail whether or not the printing of the pre-updated document data and storing of the updated document data in the desired storage location are successfully performed.

While such is the description of the document data transmitting and receiving system, the image forming apparatus, the document reading apparatus, the information processing apparatus, and the document data transmitting and receiving method in accordance with the first embodiment of the present invention. It will be appreciated that the present embodiment provided the following advantageous effects.

The storage location for the document data is added to the print job and transmitted to the printing device to print the document on a sheet of paper based on the print job. And, the storage location for the updated document data obtained by scanning the updated document updated on the sheet of paper is set based on the storage location information added to the print job, and the updated document data is transmitted and stored in the storage location which has been set. Thus, designation of the destination to store the updated document data can be done in the course of generating the print job, so that it is made possible to set easily the destination to store the updated document data in a short time. Also, since the transmitting of the print job and the designation of the destination to store the document data can be done at one time, redundant settings can be avoided.

Further, the document data can be transmitted from a remote location to the image forming apparatus via the network, and updated document obtained by updating to the document printed by the image forming apparatus can be easily confirmed.

Further, the read settings for scanning of the updated document can be eliminated by using the print settings of the print job that includes the document data of the pre-updated document. Thus, it is possible to reduce user's burden of inputting the read settings, re-setting due to erroneous read setting, and re-scanning that follows.

Further, at least one status of printing the document on the sheet of paper, outputting the sheet of paper by the image forming apparatus, reading of the document, transmitting of the read document data, and storing of the document data transmitted from the image forming apparatus is displayed. Also, completion of at least any one of the outputting of the sheet of paper by the image forming apparatus, the reading of the document, the transmitting of the read document data, and the storing of the document data transmitted from the image forming apparatus. Thus, a user can confirm whether or not the printing of the pre-updated document data and storing of the updated document data are successfully performed as well as the progress situation thereof.

Further, information of the e-mail address is added to the print job. The completion of at least any one of outputting the sheet of paper by the image forming apparatus that has received the print job, reading of the document, transmitting of the read document data, and storing of the document data that has been transmitted from the image forming apparatus. Thus, the user can confirm by an e-mail whether or not the printing of the pre-updated document data and the storing of the updated document data in the desired storage location have been successfully performed.

Further, by accessing the storage location or confirming the histories of reading, the file name of the existing document data stored in the storage location is recognized, and a file name different from the existing document data is set to the document data to be read. Thus, it is possible to prevent the pre-updated document data in the storage location from being erased therefrom, and it is also possible to eliminate user's need of inputting the file name for the updated document data. Also, when more than one user make updates to a single document data included in the print job respectively, it is possible to reduce the probability that the file names of the updated document data are overlapped.

Further, the histories of print jobs to which the storage location information is added from among the print jobs received is only displayed in the image forming apparatus. Thus, the user can easily confirm the print jobs to which the storage location is added.

### Second Embodiment

The following provides detailed description of the document data transmitting and receiving system, image forming apparatus, document reading apparatus, information processing apparatus, and the document data transmitting and receiving method in accordance with a second embodiment of the present invention.

The present embodiment differs from the first embodiment in that an authentication dialog is displayed when authentication is required before storing a document data in a storage location set by the user so that storing of the document data only carry out when the authentication has been successful. Since other points are the same as those of the first embodiment, a repeated description will be omitted or simplified.

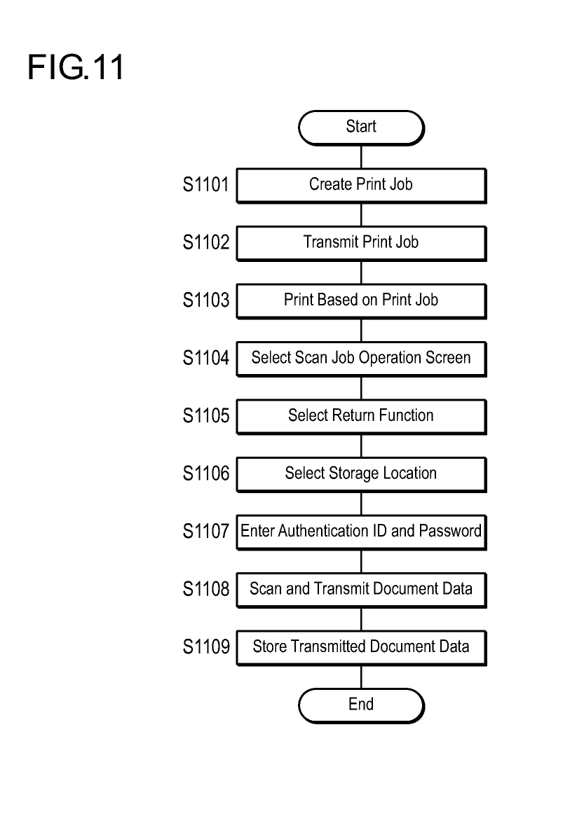

FIG. 11 is a flowchart illustrating a document transmitting and receiving method in accordance with the present embodiment.

The user operates the information processing apparatus 10 to control the printer driver so that the printer driver creates a print job that includes information of the document data, the print settings, and the storage location (S1101), and transmits the print job to the image forming apparatus 20 (S1102).

When the image forming apparatus 20 receives the print job from the information processing apparatus 10, the image forming apparatus 20 prints the document on the sheet of paper based on the print job and outputs the printed sheet of paper (S1103).

The user updates the document printed on the sheet of paper by the image forming apparatus 20, and selects the scan job operation screen 900 to be displayed on the display unit 206 of the image forming apparatus 20 (S1104).

When the return function is selected by the user on the scan job operation screen 900 (S1105), the image forming apparatus 20 displays the destination list in the scan job operation screen 900. The user places the printed sheet of paper including the updated document on the reading unit 208 of the image forming apparatus 20.

The user sets the storage location for updated document by selecting any one of the storage locations listed in the destination list in the scan job operation screen 900 (S1106).

The image forming apparatus 20 makes the display unit 206 display an authentication dialog when authentication is needed before storing the document data in the storage location that has been set in the step S1106.

When the user inputs an authentication ID and a password in the authentication dialog (S1107), the image forming apparatus 20 performs user authentication. When it is confirmed as the result of the user authentication that the user is authorized to store the document data in the storage location that has been set in the step S1106, the image forming apparatus 20 scan the updated document. And, the image forming apparatus 20 transmits an updated document data obtained by the scanning to the storage location set in the step S1106 (S1108) and stores the updated document data in that storage location (S1109).

While such is the description of the document data transmitting and receiving system, the image forming apparatus, the document reading apparatus, the information processing apparatus, and the document data transmitting and receiving method in accordance with the second embodiment of the present invention. It will be appreciated that the present embodiment provided the following advantageous effects in addition to the effect provided by the first embodiment.

When authentication is required before storing the file in the storage location set by a user, the authentication dialog is displayed for user authentication. Thus, it is possible to set in the print job the storage location subject to the user authentication as the storage location for the updated document data while ensuring system security.

### Third Embodiment

The following provides detailed description of the document data transmitting and receiving system, image forming apparatus, document reading apparatus, information processing apparatus, and the document data transmitting and receiving method in accordance with a third embodiment of the present invention.

The difference between the present embodiment and the first embodiment is as follows. In the first embodiment, the storage location of the updated document data obtained by scanning the updated document is set in accordance with selection by a user. In present embodiment, however, the image forming apparatus compares the updated document data with the pre-updated document data included in the print job received by the image forming apparatus. If the former and the latter correspond to each other, then the updated document data is stored in the same storage location as that of the pre-updated document data. Since other points are the same as those of the first embodiment, a repeated description will be omitted or simplified.

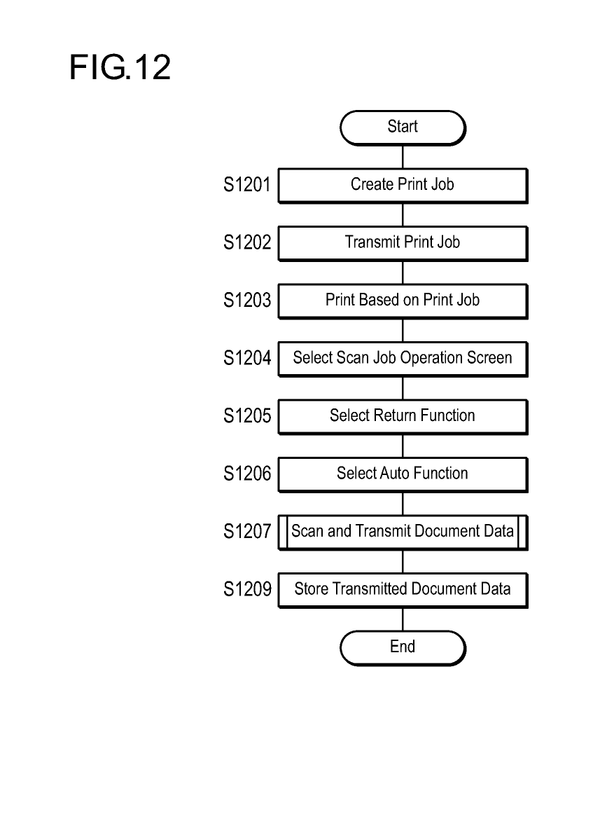

FIG. 12 is a flowchart illustrating a document transmitting and receiving method.

The user operates the information processing apparatus 10 to controls the printer driver so that the printer driver create a print job that includes information of the document data, the print settings, and the storage location (S1201), and transmits the print job to the image forming apparatus 20 (S1202).

When the print job is received from the information processing apparatus 10, the image forming apparatus 20 prints the document on the sheet of paper based on the received print job and outputs the printed sheet of paper (S1203).

The user updates the document printed on the sheet of paper by the image forming apparatus 20, and selects the scan job operation screen 900 to be displayed on the display unit 206 of the image forming apparatus 20 (S1204). The user places the printed sheet of paper including the updated document on the reading unit 208 of the image forming apparatus 20.

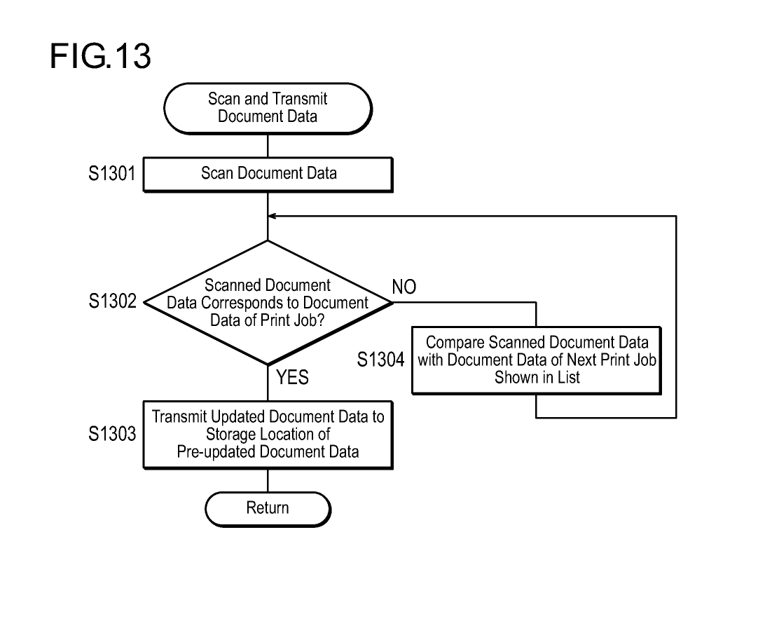

When the user selects the return function on the scan job operation screen 900 (S1205) and selects the automatic function (S1206), the image forming apparatus 20 scans the updated document in accordance with the subroutine chart of FIG. 13, which will be explained later. The image forming apparatus 20 compares the updated document data with the document data included in the print job that has been received by the image forming apparatus 20. If the former and the latter correspond to each other, then the storage location of the pre-updated document data is set as the storage location for the updated document data. The updated document data is transmitted to the storage location that has been set (S1207), and stored therein (S1208).

Here, the automatic function is selected by selecting an “Auto” button in the scan job operation screen 900. The automatic function is a function of transmitting and storing of the updated document data obtained by scanning of the updated document to and in the storage location of the pre-updated document data.

FIG. 13 is a flowchart of a subroutine of the document data transmitting and receiving method in accordance with the present embodiment.

When the automatic function is selected in the step S1206, the image forming apparatus 20 performs scanning of the updated document. Then it is judged whether or not the updated document data obtained by scanning the updated document corresponds to the document data included in the print job which is printed by the image forming apparatus 20 most lately among the print jobs whose histories are listed in the destination list of the scan job operation screen 900 (S1302). The image forming apparatus 20 compares a rasterized document (image) of the document data included in the print job with the document (image) of the updated document data obtained by scanning the updated document.

Since the updated document is added corrections and comments to pre-updated document for example, the updated document data is not completely identical with the original document data. Accordingly, the image forming apparatus 20 judges correspondence of these two documents on the basis of the fact that any suitable predetermined matching ratio has been satisfied as the result of comparison. The comparison of the documents may be conducted by the phase only correlation (POC) method.

The document data which has been compared with and judged to correspond to the updated document data in the step S1302 is the pre-updated document data of the compared updated document data.

If it has been judged that the updated document data corresponds to the pre-updated document data (YES in S1302), the image forming apparatus 20 transmits the updated document data to the storage location added to the print job including the pre-updated document data. In other words, the updated document data is transmitted to a location where the pre-updated document data is stored (S1303).

After that, the updated document data transmitted in the step S1303 is stored in the destination storage location (S1208).

If it has been judged that the updated document data does not correspond to the compared document data (NO in S1302), the image forming apparatus 20 compares the updated document data with a document data included in a print job which is printed by the image forming apparatus 20 second most lately among the print jobs whose histories are listed in the destination list (S1304).

The image forming apparatus 20 repeats the step S1302 and the step S1304 until document data that corresponds to the updated document data is detected.

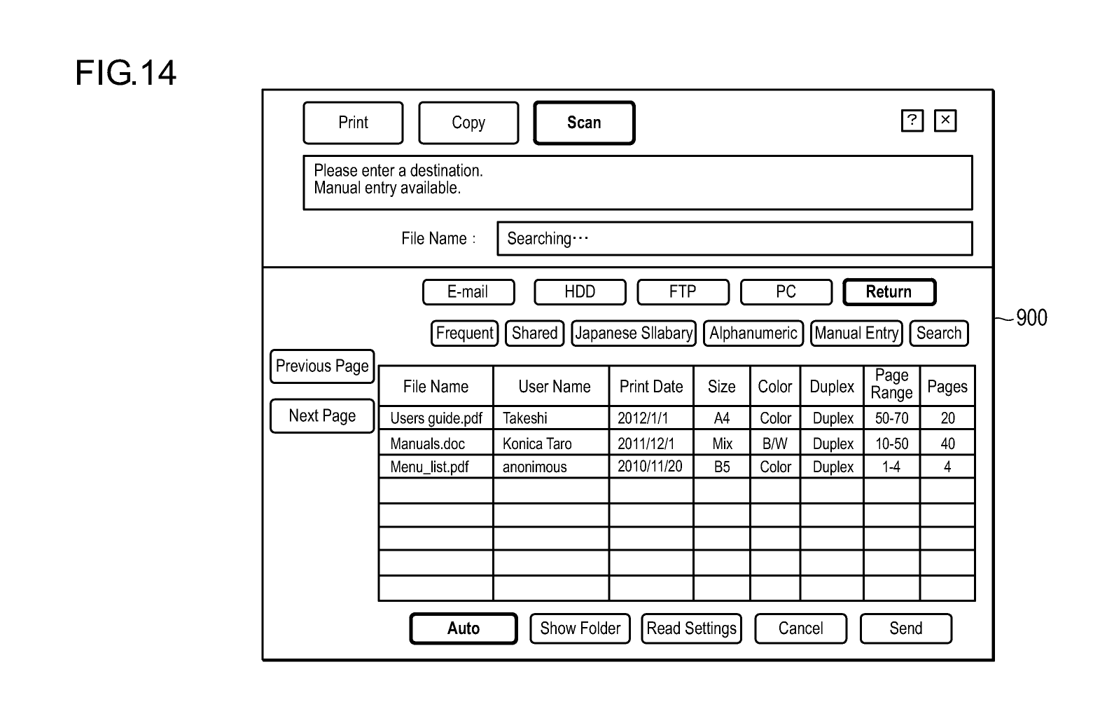

FIG. 14 is a scan job operation screen displayed on the display unit of the image forming apparatus in accordance with the present embodiment.

As shown in FIG. 14, the automatic function is selected by selecting the “Auto” button on the scan job operation screen 900.

A word of “Searching” is indicated in a “file name” field until a pre-updated document data is detected that corresponds to the updated document data obtained by scanning of the updated document.

When a document data that corresponds to the updated document data has not been detected among the document data included in the print jobs listed in the display list, the display unit 206 of the image forming apparatus 20 or the display unit 105 of the information processing apparatus 10 may display a warning message. Also, in this case, the warning message may be transmitted to an e-mail address included in the print job. Thus, a user can easily confirm the fact that the updated document data can not be transmitted to the storage location of the pre-updated document data because the storage location of the pre-updated document data is unclear.

When the user authentication of the second embodiment is to be performed in the present embodiment, the user authentication will be done immediately before the transmitting of the updated document data to the storage location after the scanning of the updated document.

While such is the description of the document data transmitting and receiving system, the image forming apparatus, the document reading apparatus, the information processing apparatus, and the document data transmitting and receiving method in accordance with the third embodiment of the present invention. It will be appreciated that the present embodiment provided the following advantageous effects in addition to the effect provided by the first embodiment.

The updated document data obtained by scanning the updated document updated on the printed sheet of paper is compared with the document data included in the print job received by the image forming apparatus. The updated document data is stored in the storage location added to the print job including the document data judged to correspond to the updated document data. Thus, the updated document data obtained by scanning of the updated document can be stored in the storage location of the pre-updated document data only by scanning of the updated document without user selection of the storage location.

### Fourth Embodiment

The following provides detailed description of the document data transmitting and receiving system, image forming apparatus, document reading apparatus, information processing apparatus, and the document data transmitting and receiving method in accordance with a fourth embodiment of the present invention.

The difference between the present embodiment and the first embodiment is as follows. In the first embodiment, the print job includes the document data, the print settings, and the storage location, and printing is performed based on the print job. Meanwhile, in present embodiment, the print job does not include the document data to be printed, and only the setting of the storage location based on the print job is performed in the image forming apparatus. Since other points are the same as those of the first embodiment, a repeated description will be omitted or simplified.

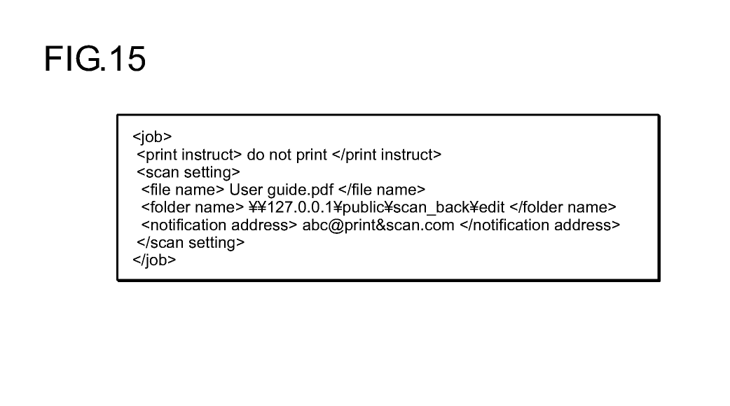

FIG. 15 is a print job configuration that does not include a document data.

As shown in FIG. 15, the print job configuration includes a print instruction and scan settings, but does not include the page settings. Specifically, a file name to be assigned to the document data obtained by scanning of the document as the scan settings, and a folder name as a directory which is the storage location information are only described, and the print job does not include the print settings and the page settings as the document data.

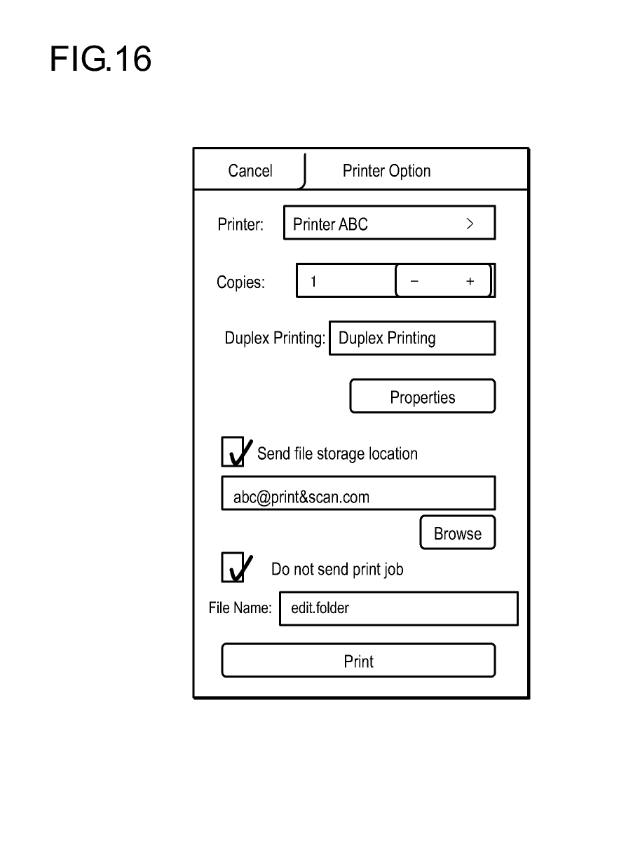

FIG. 16 is a dialog of the printer driver in a case where the print job does not include the document data.

As shown in FIG. 16, in order to include storage location in the print job, a “Send file storage location” checkbox is checked, and in order to not include the document data in the print job, a “Do not send a print job” checkbox is checked.

The “Send file storage location” checkbox may be checked by opening the dialog of the printer driver without opening the file of the document to be printed in the information processing apparatus. In this case, a default file name may be indicated in the file name field.

When the “Print” button is selected in the dialog of the printer driver with the “Do not send a print job” checkbox checked, the print job that does not include the document data is transmitted to the image forming apparatus 20. The image forming apparatus 20 lists the received print job along with the storage location included the print job in the transmission list, and sets the storage location.

In this manner, in this embodiment, the print job that does not include the document data is transmitted to the image forming apparatus 20, so that only the storage location is set for the image forming apparatus 20. Thus, the setting of the storage location for the image forming apparatus 20 is done by transmitting of the print job, making it possible to easily set in a short time the destination to store the document data while unnecessary printing does not perform.

Although the document transmitting and receiving system, the image forming apparatus, the document reading apparatus, the information processing apparatus, and the document transmitting and receiving method according to the embodiments of the present invention have been described, the document transmitting and receiving system, the image forming apparatus, the document reading apparatus, the information processing apparatus, and the document transmitting and receiving method according to the present invention are not limited to the embodiments mentioned above.

For example, in the above-described embodiments, printing by the print job and reading of the document on the sheet of paper are performed by a single image forming apparatus. Alternatively, the reading of the document on the sheet of paper may be done by a scanner as a separate document reading apparatus. In this case, the scanner may receive the print job and make storage location settings.

Also, a warning message may be displayed and transmitting of the updated document data may be suspended to alert a user when the number of pages of the print settings does not correspond to the number of pages of the document data that has been read as a result of reading the updated document by using the print setting.

Also, when the information processing apparatus with high portability is used, the image forming apparatus may not be able to transmit the document file due to failure to connect to the information processing apparatus because the information processing apparatus might be out of its service area. In this case, when reconnection is accomplished, the information processing apparatus may notify the image forming apparatus of the reconnection, and the notification signal may serve as a trigger for the updated document data to be transmitted from the image forming apparatus to the information processing apparatus.

Also, in the third embodiment, the updated document data is compared with the document data included in the print job. However, for example a bar-code data may be added to the document data included in the print job so that the bar-code data added to the document data included in the print job is compared with the bar-code data included in the updated document data.

What is claimed is:

1. A document data transmitting and receiving system comprising:
an information adding unit to add information of a storage location for document data to a print job;
a print job transmitting unit to transmit said print job to which said information of storage location for document data added by said information adding unit;
a print job receiving unit to receive said print job transmitted by said print job transmitting unit;
a printing unit to print on a print medium based on said print job received by said print job receiving unit and output said printed print medium;
a reading unit to read a document existing on said print medium printed by said printing unit as document data;
a storage location setting unit to set a storage location for said document data read by said reading unit based on any one of said information of storage location added to said print jobs received by said print job receiving unit; and
a document data transmitting unit to transmit said document data read by said reading unit to said storage location that is set by said storage location setting unit to store.

2. The document data transmitting and receiving system as claimed in claim 1, further comprising:
a storage location display unit to display said storage locations based on said information added to each of said print jobs received by said print job receiving unit along with histories of said print jobs received by said print job receiving unit so that said storage locations are selectable by a user, wherein
said storage location setting unit sets said storage location selected by the user from among said storage locations displayed by said storage location display unit as said storage location for document data.

3. The document data transmitting and receiving system as claimed in claim 1, further comprising:
a print setting display unit to display a print setting of said print job received by said print job receiving unit so that said print setting is selectable by a user; and
a read setting unit to set a read setting for said reading unit to read said document based on said print setting selected by the user from among said print settings displayed by said print setting display unit.

4. The document data transmitting and receiving system as claimed in claim 1, further comprising:
a comparing and judging unit to compare said document data included in said print job received by said print job receiving unit with said document data read by said reading unit, and judge that these documents are correspondent to each other if these documents are correspondent at least partly to each other, wherein
if it is judged by said comparing and judging unit that said document data included in said print job and said document data read by said reading unit correspond to each other, said storage location setting unit sets said storage location based on said information added to said print job includes said document data that judged to correspond to said document data read by said reading unit as the storage location for said document data read by said reading unit.

5. The document data transmitting and receiving system as claimed in claim 4, further comprising:
a read setting unit to set read setting for said reading unit to read said document based on print setting of said print job includes document data that judged to correspond to said document data read by said reading unit if it is judged by said comparing and judging unit that said document data included in said print job corresponds to said document data read by said reading unit.

6. The document data transmitting and receiving system as claimed in claim 1, further comprising:
a status display unit to display a status of at least any one of printing of said document on said print medium by said printing unit, outputting of said print medium by said printing unit, reading of said document by said reading unit, transmitting of said document data by said document data transmitting unit, or storing of said document data transmitted by said document data transmitting unit, or display completion of at least any one of outputting of said print medium by said printing unit, reading of said document by said reading unit, transmitting of said document data by said document data transmitting unit, or storing of said document data transmitted by said document data transmitting unit.

7. The document data transmitting and receiving system as claimed in claim 1, wherein
said information adding unit further adds information of e-mail address to said print job, and
said system further comprises a mail-transmitting unit to transmit an e-mail notifying completion of any one of outputting of said print medium printed based on said print job by said printing unit, reading of said document by said reading unit, transmitting of said document data by said document data transmitting unit, or storing of said document data transmitted by said document data transmitting unit, to said e-mail address based on said information added to said print job, when said completion has resulted.

8. The document data transmitting and receiving system as claimed in claim 1, further comprising:
a user interface display unit to access said storage location set by said storage location setting unit prior to transmitting of said document data by said document data transmitting unit, and display an interface for entering authentication information by a user for user authentication when it has been judged that the user authentication is required in order that said document data is allowed to be stored in said storage location accessed.

9. The document data transmitting and receiving system as claimed in claim 1, further comprising:
a file name setting unit to recognize file names of existing document data stored in said storage location by accessing said storage location set by said storage location setting unit or confirming histories of documents read by said reading unit, and set a file name for said document data read by said reading unit to a file name different from file names of said existing document data.

10. The document data transmitting and receiving system as claimed in claim 2, wherein
said storage location display unit displays only said print job histories for said print jobs to which said information of storage location is added from among said print jobs received by said print job receiving unit.

11. The document data transmitting and receiving system as claimed in claim 1, wherein
said print jobs to which said information of storage location is added include a print job not including said document data to be printed.

12. The document data transmitting and receiving system as claimed in claim 4, further comprising:
a warning display unit to display a warning message when it has been judged by said comparing and judging unit that said document data read by said reading unit does not correspond to any one of said document data included in said print jobs as the result of comparing said document data included in said print jobs with said document data read by said reading unit.

13. The document data transmitting and receiving system as claimed in claim 7, wherein
said a mail-transmitting unit transmits an e-mail for notification of warning to said e-mail address based on said information added to said print job when it has been judged by said comparing and judging unit that said document data read by said reading unit does not correspond to any one of said document data included in said print jobs as the result of comparing said document data included in said print jobs with said document data read by said reading unit.

14. An image forming apparatus comprising:
a print job receiving unit to receive a print job to which information of storage location for document data is added;
a printing unit to print on a print medium based on said print job received by said print job receiving unit and output said printed print medium;
a reading unit to read a document existing on said print medium printed by said printing unit as document data;
a storage location setting unit to set a storage location for said document data read by said reading unit based on any one of said information of storage location added to each of print jobs received by said print job receiving unit; and
a document data transmitting unit to transmit said document data read by said said reading unit to said storage location set by said storage location setting unit to store.

15. The image forming apparatus as claimed in claim 14, further comprising:
a storage location display unit to display said storage locations based on said information added to each of said print jobs received by said print job receiving unit along with histories of said print jobs received by said print job receiving unit so that said storage locations are selectable by a user, wherein
said storage location setting unit sets said storage location selected by the user from among said storage locations displayed by said storage location display unit as said storage location for document data.

16. The image forming apparatus as claimed in claim 14, further comprising:
a print setting display unit to display a print setting of said print job received by said print job receiving unit so that said print setting is selectable by a user; and
a read setting unit to set a read setting for said reading unit to read said document based on said print settings selected by the user from among said print settings displayed by said print setting display unit.

17. The image forming apparatus as claimed in claim 14, further comprising:
a comparing and judging unit to compare said document data included in said print job received by said print job receiving unit with said document data read by said reading unit, and judge that these documents are correspondent to each other if these documents are correspondent at least partly to each other, wherein
if it is judged by said comparing and judging unit that said document data included in said print job and said document data read by said reading unit correspond to each other, said storage location setting unit sets said storage location based on said information added to said print job includes said document data that judged to correspond to said document data read by said reading unit as the storage location for said document data read by said reading unit.

18. The image forming apparatus as claimed in claim 17, further comprising:
a read setting unit to set read setting for said reading unit to read said document based on print setting of said print job includes document data that judged to correspond to said document data read by said reading unit if it is judged by said comparing and judging unit that said document data included in said print job corresponds to said document data read by said reading unit.

19. The image forming apparatus as claimed in claim 14, further comprising:
a status display unit to display a status of at least any one of printing of said document on said print medium by said printing unit, outputting of said print medium by said printing unit, reading of said document by said reading unit, transmitting of said document data by said document data transmitting unit, or storing of said document data transmitted by said document data transmitting unit, or display completion of at least any one of outputting of said print medium by said printing unit, reading of said document by said reading unit, transmitting of said document data by said document data transmitting unit, or storing of said document data transmitted by said document data transmitting unit.

20. The image forming apparatus as claimed in claim 14, wherein
said print job is further added information of e-mail address, and
said image forming apparatus further comprises a mail-transmitting unit to transmit an e-mail notifying completion of any one of outputting of said print medium printed based on said print job by said printing unit, reading of said document by said reading unit, transmitting of said document data by said document data transmitting unit, or storing of said document data transmitted by said document data transmitting unit, to said e-mail address based on said information added to said print job, when said completion has resulted.

21. The image forming apparatus as claimed in claim 14, further comprising:
a user interface display unit to access said storage location set by said storage location setting unit prior to transmitting of said document data by said document data transmitting unit, and display an interface for entering authentication information by a user for user authentication when it has been judged that the user authentication is required in order that said document data is allowed to be stored in said target storage location accessed.

22. The image forming apparatus as claimed in claim 14, further comprising:
a file name setting unit to recognize file names of existing document data stored in said storage location by accessing said storage location set by said storage location setting unit or confirming histories of documents read by said reading unit, and set a file name for said document data read by said reading unit to a file name different from file names of said existing document data.

23. The image forming apparatus as claimed in claim 15, wherein
said storage location display unit displays only said print job histories for said print jobs to which said information of storage location is added only from among said print jobs received by said print job receiving unit.

24. The image forming apparatus as claimed in claim 14,
wherein said print jobs include a print job not including said document data to be printed.

25. The image forming apparatus as claimed in claim 17, further comprising:
a warning display unit to display a warning message when it has been judged by said comparing and judging unit that said document data read by said reading unit does not correspond to any one of said document data included in said print jobs as the result of comparing said document data included in said print jobs with said document data read by said reading unit.

26. The image forming apparatus as claimed in claim 20, wherein
said a mail-transmitting unit transmits an e-mail for notification of warning to said e-mail address based on said information added to said print job when it has been judged by said reading unit by said comparing and judging unit that said document data read by said reading unit does not correspond to any one of said document data included in said print jobs as the result of comparing said document data included in said print jobs with said document data read by said reading unit.

27. A document reading apparatus comprising:
a print job receiving unit to receive a print job to which information of storage location for document data is added;
a reading unit to read a document existing on said print medium printed by a printing apparatus as document data;
a storage location setting unit to set a storage location for said document data read by said reading unit based on any one of said information of storage location for document data added to said print jobs received by said print job receiving unit; and
a document data transmitting unit to transmit said document data read by said reading unit to said storage location that is set by said storage location setting unit to store.

28. The document reading apparatus as claimed in claim 27, further comprising:
a storage location display unit to display said storage locations based on said information added to each of said print jobs received by said print job receiving unit along with histories of said print jobs received by said print job receiving unit so that said storage locations are selectable by a user, wherein
said storage location setting unit sets said storage location selected by the user from among said storage locations displayed by said storage location display unit as said storage location for document data.

29. The document reading apparatus as claimed in claim 27, further comprising:
a print setting display unit to display a print setting of said print job received by said print job receiving unit so that said print setting is selectable by a user; and
a read setting unit to set a read setting for said reading unit to read said document based on said print setting selected by the user from among said print settings displayed by said print setting display unit.

30. The document reading apparatus as claimed in claim 27, further comprising:
a comparing and judging unit to compare said document data included in said print job received by said print job receiving unit with said document data read by said reading unit, and judge that those documents are correspondent to each other if these documents are correspondent at least partly to each other, wherein
if it is judged by said comparing and judging unit that said document data included in said print job and said document data read by said reading unit correspond to each other, said storage location setting unit sets said storage location based on said information added to said print job includes said document data that judged to correspond to said document data read by said reading unit as the storage location for said document data read by said reading unit.

31. The document reading apparatus as claimed in claim 30, further comprising:
a read setting unit to set read setting for said reading unit to read said document based on print setting of said print job includes document data that judged to correspond to said document data read by said reading unit if it is judged by said comparing and judging unit that said document data included in said print job corresponds to said document data read by said reading unit.

32. The document reading apparatus as claimed in claim 27, further comprising:
a status display unit to display a status of at least any one of printing of said document on said print medium by said printing apparatus, outputting of said print medium by said printing apparatus, reading of said document by said reading unit, transmitting of said document data by said document data transmitting unit, or storing of said document data transmitted by said document data transmitting unit, or display completion of at least any one of outputting of said print medium by said printing apparatus, reading of said document by said reading unit, transmitting of said document data by said document data transmitting unit, or storing of said document data transmitted by said document data transmitting unit.

33. The document reading apparatus as claimed in claim 27, wherein
said print job is further added information of e-mail address, and
said document reading apparatus further comprises a mail-transmitting unit to transmit an e-mail notifying completion of any one of outputting of said print medium printed based on said print job by said printing apparatus, reading of said document by said reading unit, transmitting of said document data by said document data transmitting unit, or storing of said document data transmitted by said document data transmitting unit, to said e-mail address based on said information added to said print job, when said completion has resulted.

34. The document reading apparatus as claimed in claim 27, further comprising:
a user interface display unit to access said storage location set by said storage location setting unit prior to transmitting of said document data by said document data transmitting unit, and display an interface for entering authentication information by a user for user authentication when it has been judged that the user authentication is required in order that said document data is allowed to be stored in said storage location accessed.

35. The document reading apparatus as claimed in claim 27, further comprising:
a file name setting unit to recognize file names of existing document data stored in said storage location by accessing said storage location set by said storage location setting unit or confirming histories of documents read by said reading unit, and set a file name for said document data read by said reading unit to a file name different from file names of said existing document data.

36. The document reading apparatus as claimed in claim 28, wherein
said storage location display unit displays only said print job histories for said print jobs to which said information of storage location is added from among said print jobs received by said print job receiving unit.

37. The document reading apparatus as claimed in claim 27, wherein
said print jobs include a print job not including said document data to be printed.

38. The document reading apparatus as claimed in claim 27, further comprising:
a warning display unit to display a warning message when it has been judged by said comparing and judging unit that said document data read by said reading unit does not correspond to any one of said document data included in said print jobs as the result of comparing said document data included in said print jobs with said document data read by said reading unit.

39. The document reading apparatus as claimed in claim 30, wherein
said a mail-transmitting unit transmits an e-mail for notification of warning to said e-mail address based on said information added to said print job when it has been judged by said comparing and judging unit that said document data read by said reading unit does not correspond to any one of said document data included in said print jobs as the result of comparing said document data included in said print jobs with said document data read by said reading unit.

40. An information processing apparatus comprising:
an information adding unit to add information of a storage location for document data to a print job; and
a print job transmitting unit to transmit said print job to which said information of storage location for document data added by said information adding unit.

41. The information processing apparatus as claimed in claim 40, wherein
said print jobs include a print job not including said document data to be printed.

42. A document data transmitting and receiving method comprising the steps of:
(a) adding information of storage location for document data to a print job;
(b) transmitting said print job to which said information of said storage location for document data added in said step (a);
(c) receiving said print job transmitted in said step (b);
(d) printing a document on a print medium based on said print job received in said step (c) and outputting said printed print medium;
(e) reading a document existing on said print medium printed in said step (d) as document data;
(f) setting a storage location for said document data read in said step (e) based on any one of said information of storage location for document data added to said print jobs received in said step (c); and
(g) transmitting said document data read in said step (e) to said storage location that is set in said step (f) to store.

43. The document data transmitting and receiving method as claimed in claim 42, further comprising a step of:
(h) displaying said storage locations based on said information added to each of said print jobs received in said step (c) along with histories of said print jobs received in said step (c) so that said storage locations are selectable by a user, wherein
in said step (f), said storage location selected by the user from among said storage locations displayed in said step (h) is set as said storage location for said document data.

44. The document data transmitting and receiving method as claimed in claim 42, further comprising the steps of:
(i) displaying a print setting of said print job received in step (c) so that said print setting is selectable by a user; and
(j) setting a read setting for reading said document in step (e) based on said print setting selected by the user from among said print setting displayed in said step (i).

45. The document data transmitting and receiving method as claimed in claim 42, further comprising the step of:
(k) comparing said document data included in said print job received in step (c) with said document data read in step (e), and judging that these documents are correspondent to each other if these documents are correspondent at least partly to each other, wherein
in said step (f), if it is judged in said step (k) that said document data included in said print job and said document data read in said step (e) correspond to each other, said storage location is set based on said information added to said print job includes said document data that judged to correspond to said document data read in said step (e) as the storage location for said document data read in said step (e).

46. The document data transmitting and receiving method as claimed in claim 45, further comprising the step of:
(l) setting read setting for reading said document in said step (e) based on print setting of said print job includes document data that judged to correspond to said document data read in said step (e), if it is judged in said step (k) that said document data included in said print job corresponds to said document data read in said step (e).

47. The document data transmitting and receiving method as claimed in claim 42, further comprising the step of:
(m) displaying a status of at least any one of printing of said document on said print medium in said step (d), outputting of said print medium in said step (d), reading of said document in said step (e), transmitting of said document data in said step (g), or storing of said document data transmitted in said step (g), or displaying completion of at least any one of outputting of said print medium in said step (d), reading of said document in said step (e), transmitting of said document data in said step (g), or storing of said second document data transmitted in said step (g).

48. The document data transmitting and receiving method as claimed in claim 42, further comprising the steps of:
(n) adding information of e-mail address to said print job; and
(o) transmitting an e-mail notifying completion of any one of outputting of said print medium printed based on said print job in said step (d), reading of said document in said step (e), transmitting of said document data in said step (g), or storing of said document data transmitted in said step (g), to said e-mail address based on said information added to said print job, when said completion has resulted.

49. The document data transmitting and receiving method as claimed in claim 42, further comprising a step of:
(p) accessing said storage location set in said step (f) prior to transmitting of said document data in said step (g), and displaying an interface for entering authentication information by a user for user authentication when it has been judged that the user authentication is required in order that said document data is allowed to be stored in said storage location accessed.

50. The document data transmitting and receiving method as claimed in claim 42, further comprising a step of:
(q) recognizing file names of existing document data stored in said storage location by accessing said storage location set in said step (f) or confirming histories of documents read in said step (e), and setting a file name for said document data read in said step (e) to a file name different from file names of said existing document data.

51. The document data transmitting and receiving method as claimed in claim 43, wherein
in said step (h), said print job histories for said print jobs to which said information of storage location is added from among said print jobs received in said step (c) are only displayed.

52. The document data transmitting and receiving method as claimed in claim 42, wherein
in said step (a), said print jobs to which said information of storage location is added in said step (a) include a print job not including said document data to be printed.

53. The document data transmitting and receiving method as claimed in claim 45, further comprising a step of
(r) displaying a warning message when it has been judged in said step (k) that said document data read in said step (e) does not correspond to any one of said document data included in said print jobs as the result of comparing said document data included in said print jobs with said document data read in said step (e).

54. The document data transmitting and receiving method as claimed in claim 48, further comprising a step of
(s) transmitting an e-mail for notification of warning to said e-mail address based on said information added to said print job in said step (n) when it has been judged in said step (k) that said document data read in said step (e) does not correspond to any one of said document data included in said print jobs as the result of comparing said document data included in said print jobs with said document data read in said step (e).
